(19) United States
(12) Patent Application Publication
(10) Pub. No.: US 2021/0012128 A1
(43) Pub. Date: Jan. 14, 2021

(54) DRIVER ATTENTION MONITORING METHOD AND APPARATUS AND ELECTRONIC DEVICE

(71) Applicant: BEIJING SENSETIME TECHNOLOGY DEVELOPMENT CO., LTD., Beijing (CN)

(72) Inventors: Fei WANG, Beijing (CN); Shiyao HUANG, Beijing (CN); Chen QIAN, Beijing (CN)

(21) Appl. No.: 17/034,307

(22) Filed: Sep. 28, 2020

Related U.S. Application Data
(63) Continuation of application No. PCT/CN2019/119936, filed on Nov. 21, 2019.

(30) Foreign Application Priority Data
Mar. 18, 2019 (CN) 201910205328.X

(51) Int. Cl. G06K 9/00; G06K 9/62; B60W 40/09; B60W 50/14; G06N 3/02

(52) U.S. Cl. CPC G06K 9/00845; G06K 9/00228; G06K 9/00604; G06K 9/00744; B60W 2540/229; B60W 40/09; B60W 50/14; G06N 3/02; B60W 2540/225; G06K 9/6259

(57) ABSTRACT

Disclosed in the present disclosure are a driver attention monitoring method and apparatus and an electronic device. The method includes: capturing, by a camera arranged on a vehicle, a video of a driving area of the vehicle; determining, according to each of multiple frames of face images of a driver in the driving area included in the video, a type of a gazing area of the driver in the frame of face image, where the gazing area of each frame of face image is one of multiple types of defined gazing areas obtained by dividing a space area of the vehicle in advance; and determining an attention monitoring result of the driver according to a type distribution of gazing areas of the frames of face images included within at least one sliding time window in the video.

The present application is a continuation of International Application No. PCT/CN2019/119936, filed on Nov. 21, 2019, which claims priority to Chinese Patent Application No. 201910205328.X, filed on Mar. 18, 2019. The disclosures of International Application No. PCT/CN2019/119936 and Chinese Patent Application No. 201910205328.X are hereby incorporated by reference in their entireties.

### BACKGROUND

As vehicles on roads are growing more and more, how to prevent road traffic accidents has received more and more attention. Human factors account for a large proportion of causes of road traffic accidents, and include distracted driving caused by lack of concentration, attention reduction, etc. of drivers.

### SUMMARY

The present disclosure relates to the technical field of image processing, and in particular, to a driver attention monitoring method and apparatus and an electronic device.

The present disclosure provides a driver attention monitoring technical solution.

According to the first aspect, provided is a driver attention monitoring method, including: capturing, by a camera arranged on a vehicle, a video of a driving area of the vehicle; determining, according to each of multiple frames of face images of a driver in the driving area included in the video, a type of a gazing area of the driver in the frame of face image, where the gazing area of the frame of face image is one of multiple types of defined gazing areas obtained by dividing a space area of the vehicle in advance; and determining an attention monitoring result of the driver according to a type distribution of gazing areas of the frames of face images included within at least one sliding time window in the video.

According to the second aspect, provided is a driver attention monitoring apparatus, including: a memory storing processor-executable instructions; and a processor arranged to execute the stored processor-executable instructions to perform operations of: capturing, by a camera arranged on a vehicle, a video of a driving area of the vehicle; determining, according to each of multiple frames of face images of a driver in the driving area comprised in the video, a type of a gazing area of the driver in the frame of face image, wherein the gazing area of the frame of face image is one of multiple types of defined gazing areas obtained by dividing a space area of the vehicle in advance; and determining an attention monitoring result of the driver according to a type distribution of gazing areas of the frames of face images comprised within at least one sliding time window in the video.

According to the third aspect, provided is a non-transitory computer-readable storage medium having stored thereon computer-readable instructions that, when executed by a processor, cause the processor to perform a driver attention monitoring method, the method including: capturing, by a camera arranged on a vehicle, a video of a driving area of the vehicle; determining, according to each of multiple frames of face images of a driver in the driving area comprised in the video, a type of a gazing area of the driver in the frame of face image, wherein the gazing area of the frame of face image is one of multiple types of defined gazing areas obtained by dividing a space area of the vehicle in advance; and determining an attention monitoring result of the driver according to a type distribution of gazing areas of the frames of face images comprised within at least one sliding time window in the video.

### BRIEF DESCRIPTION OF THE DRAWINGS

The drawings here incorporated in the description and constituting a part of the description describe the embodiments of the present disclosure and are intended to explain the technical solutions of the present disclosure together with the description.

FIG. 1 is a schematic flowchart of a driver attention monitoring method provided in embodiments of the present disclosure.

FIG. 2 is a schematic diagram of division of a gazing area provided in embodiments of the present disclosure;

FIG 3. is a schematic flowchart of another driver attention monitoring method provided in embodiments of the present disclosure.

FIG. 4 is a schematic flowchart of a training method for a neural network provided in embodiments of the present disclosure.

FIG. 5 is a schematic flowchart of another training method for a neural network provided in embodiments of the present disclosure.

FIG. 6 is a schematic flowchart of another driver attention monitoring method provided in embodiments of the present disclosure.

FIG. 7 is a schematic structural diagram of a driver attention monitoring apparatus provided in embodiments of the present disclosure.

FIG. 8 is a schematic structural diagram of a training unit provided in embodiments of the present disclosure.

FIG. 9 is a schematic structural diagram of hardware of a driver attention monitoring apparatus provided in embodiments of the present disclosure.

### DETAILED DESCRIPTION

In order to make a person skilled in the art better understand solutions of the present disclosure, the technical solutions in embodiments of the present disclosure are clearly and fully described below with reference to the accompanying drawings in the embodiments of the present disclosure. Apparently, the described embodiments are merely some of the embodiments of the present disclosure, but not all the embodiments. Based on the embodiments of the present disclosure, all other embodiments obtained by a person of ordinary skill in the art without involving an inventive effort shall fall within the scope of protection of the present disclosure.

Terms “first”, “second”, etc. in the description, the claims, and the foregoing drawings of the present disclosure are used for distinguishing different objects, rather than describing specific orders. In addition, terms “include” and “have” and any variant thereof are intended to cover non-exclusive inclusion. For example, the process, method, system, product, or device including a series of steps or units is not limited to listed steps or units, but according to some embodiments, may further include steps or units that are not listed, or according to some embodiments, may further include other steps or units inherent to the process, method, product, or device.

The mention of phrase “embodiment” in the text indicates that specific features, structures or properties described in combination of the embodiments can be incorporated in at least one embodiment of the present disclosure. The phrase present at different positions of the description does not necessarily refer to the same embodiment, and is likewise not an independent or alternate embodiment incompatible with other embodiments. A person skilled in the art explicitly and implicitly understands that the embodiments described in the text can be combined with other embodiments.

In order to explain the technical solutions in the embodiments or background of the present disclosure more clearly, the accompanying drawings required for describing the embodiments or background are explained below.

The embodiments of the present disclosure are described below with reference to the accompany drawings in the embodiments of the present disclosure.

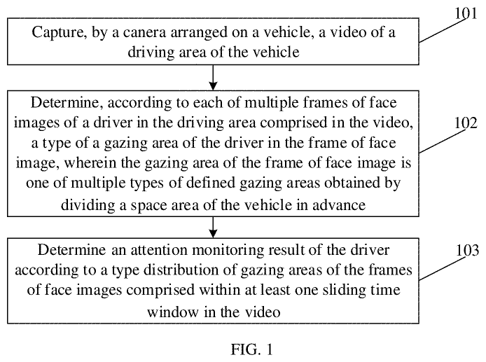

Referring to FIG. 1, FIG. 1 is a schematic flowchart of a driver attention monitoring method provided in embodiments of the present disclosure.

In 101, a video of a driving area of a vehicle is captured by a camera arranged on the vehicle.

In embodiments of the present disclosure, the driving area includes an in-vehicle driving cab area. The camera can be mounted on any area on the vehicle where the driving area can be photographed. For example, the camera can be mounted at an in-vehicle center console or a front windshield, can also be mounted at a vehicle rearview mirror, and can also be mounted at A pillar of the vehicle. In addition, there may be one or more cameras. The mounting position of the camera and the specific number of the cameras are not limited in the embodiments of the present disclosure.

In some possible implementations, the video of the driving area is obtained by performing video photography on the in-vehicle driving cab area with the camera mounted at the vehicle rearview mirror. According to some embodiments, upon receipt of a specific instruction, the camera can capture the video of the driving area of the vehicle. For example, vehicle start (such as ignition start and button start) is taken as an instruction for the camera to capture the video, so as to reduce power consumption of the camera; and for another example, the video of the driving area is captured by controlling the camera by a terminal connected to the camera, so as to achieve remote control to the camera. It can be understood that the camera may be connected to the terminal in a wireless or wired manner. The specific connection manner between the camera and the terminal.

In 102, according to each of multiple frames of face images of a driver in the driving area included in the video, a type of a gazing area of the driver in the frame of face image is determined, where the gazing area of the frame of face image is one of multiple types of defined gazing areas obtained by dividing a space area of the vehicle in advance.

In the embodiments of the present disclosure, the face image of the driver can include the entire head of the driver, and can also include a facial profile and facial features of the driver. Any frame image in the video can be taken as the face image of the driver; alternately, a face area image of the driver can be detected from any frame image in the video and then taken as the face image of the driver. The foregoing approach of detecting the face area image of the driver may be any face detection algorithm. No specific limitation is made thereto in the present disclosure.

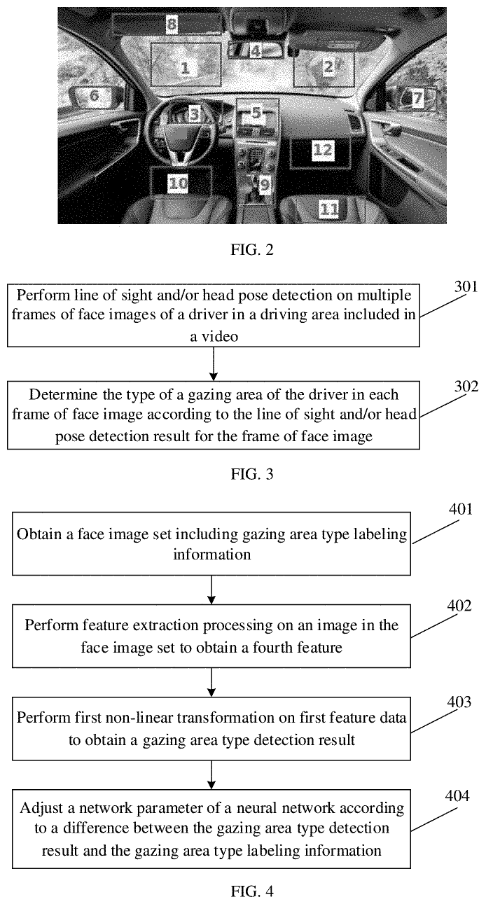

In the embodiments of the present disclosure, multiple different areas obtained by dividing an in-vehicle space can be taken as foregoing multiple different types of areas, or multiple different areas obtained by dividing an in-vehicle space and an out-vehicle space can be taken as foregoing multiple different types of gazing areas. For example, FIG. 2 illustrates an approach for gazing area type division provided in the present disclosure. As shown in FIG. 2, multiple types of gazing areas are obtained by dividing the space area of the vehicle, and include two or more of: a left front windshield area (gazing area No. 1), a right front windshield area (gazing area No. 2), a dashboard area (gazing area No. 3), an in-vehicle rearview mirror area (gazing area No. 4), a center console area (gazing area No. 5), a left rearview mirror area (gazing area No. 6), a right rearview mirror area (gazing area No. 7), a visor area (gazing area No. 8), a shift lever area (gazing area No. 9), an area below a steering wheel (gazing area No. 10), a front passenger seat area (gazing area No. 11), or a glove compartment area in front of a front passenger seat (gazing area No. 12). The use of the approach in division of the vehicle space area facilitates targeted attention monitoring for the driver; and various possible areas on which attention of the driver in a driving state may be put are fully considered in the foregoing approach, so as to facilitate forward targeted or full-space attention monitoring for the driver, thereby improving accuracy and precision of attention monitoring for the driver.

It should be understood that since vehicles of different models have different space distributions, gazing area type division can be performed according to the model. For example, in FIG. 2, a driving cab is at the left side of the vehicle, and in normal driving, a line of sight of the driver generally falls on the left front windshield area; however, for a vehicle having the driving cab at the right side of the vehicle, in normal driving, the line of sight of the driver generally falls on the right front windshield area, and thus apparently, gazing area type division should be different from that in FIG. 2. In addition, gazing area type division can also be performed according to personal preferences of users. For example, if a user thinks that the area of the screen of a center console is too small and comfort apparatuses such as an air conditioner and a loudspeaker are preferably controlled by means of a terminal having a larger screen area, the center console area in the gazing area can be adjusted according to a placement position of the terminal. Gazing area type division can also be performed according to specific conditions in other manners. The approach for gazing area type division is not limited in the present disclosure.

Eyes are the main sensory organs for the driver to get information about road conditions, and the area where the line of sight of the driver is positioned largely reflects an attention status of the driver. The type of the gazing area of the driver in each frame of face image can be determined by processing multiple frames of face images of the driver in the driving area included in the video, so as to achieve attention monitoring for the driver. In some possible implementations, the face image of the driver is processed to obtain a line of sight direction of the driver in the face image, and the type of the gazing area of the driver in the face image is determined according to a preset mapping relationship between the line of sight direction and the type of the gazing area. In other possible implementations, a feature is extracted from the face image of the driver, and the type of the gazing area of the driver in the face image is determined according to the extracted feature. In one optional example, the obtained type of the gazing area is a predetermined serial number corresponding to each gazing area.

In 103, an attention monitoring result of the driver is determined according to the type distribution of gazing areas of the frames of face images included within at least one sliding time window in the video.

In the embodiments of the present disclosure, the size of the sliding time window and a sliding step size can be pre-configured durations, and can also be the number of face images. In some possible implementations, the size of the sliding time window is 5 seconds and the sliding step size is 0.1 second, and thus at the current time, if the start time of the sliding time window is set to be 10:40:10 and the end time to be 10:40:15, then after 0.1 second passes, the start time of the sliding time window is 10:40:15.1 and the end time is 10:40:15.1. It should be understood that the foregoing times are all times when the camera captures the video. In other possible implementations, the frames of faces images in the video are numbered in an ascending order of time when the video is captured. For example, the serial number of the face image captured at 10:45:15 is 1, the serial number of the face image captured at 10:40:15.1 is 2, and so on. In the case that the size of the sliding time window is set to be 10 frames of face images and the sliding step size is set to be one frame of face image, at the current time, if the serial number of the first frame of face image within the sling time window is set to be 5 and the series number of the last frame of face image within the sliding time window is set to be 14, then when the sliding time window proceeds by one sliding step size, the series number of the first frame of face image within the sliding time window is 6, and the serial number of the last frame of face image within the sliding time window is 15.

In some optional embodiments of the present disclosure, the attention monitoring result can include distracted driving, or the attention monitoring result can include fatigue driving, or the attention monitoring result can include both distracted driving and fatigue driving. According to some embodiments, the attention monitoring result may include a distracted driving level, or may include a fatigue driving level, or may include both a distracted driving level and a fatigue driving level. Since in a vehicle driving process, the line of sight of the driver may switch among different gazing areas, the type of the gazing area of the driver in the face image captured at a different time will also change, accordingly. Taking FIG. 2 as an example, in normal driving, the line of sight of the driver is more likely to be in gazing area No. 1; due to the need to observe road conditions and vehicle conditions, the line of sight of the driver is less likely to be in gazing areas No. 2, 3, 4, 6, and 7 than in gazing area No. 1; moreover, the line of sight of the driver is less likely to be in gazing areas No. 5, 8, 9, 10, 11, and 12 than in the preceding two situations. Therefore, the type distribution of the gazing areas of the driver within a sliding time window is determined according to the type of the gazing area of each frame of face image within the sliding time window, and then the attention monitoring result is determined according to the type of the gazing area of the driver.

In some possible implementations, taking the gazing area type division in FIG. 2 as an example, a first ratio threshold of gazing area No. 1 is set as 60%, a second ratio threshold of gazing areas No. 2, 3, 4, 6, and 7 is set as 40%, and a second ratio threshold of gazing areas No. 5, 8, 9, 10, 11, and 12 is set as 15%, where when the ratio of the line of sight of the driver in gazing area No. 1 within any sliding time window is less than or equal to 60%, it is determined that the attention monitoring result is the distracted driving; when the ratio of the line of sight of the driver in gazing areas 2, 3, 4, 6, and 7 within any sliding time window is greater than or equal to 40%, it is determined that the attention monitoring result is the distracted driving; when the ratio of the line of sight of the driver in gazing areas No. 5, 8, 9, 10, 11, and 12 within any sliding time window is greater than or equal to 15%, it is determined that the attention monitoring result is the distracted driving; if no distracted driving of the driver is monitored, it is determined that the attention monitoring result is non-distracted driving. For example, among ten frames of face images within one sliding time window, four frames of face images have the gazing areas of type 1, three frames of face images have the gazing areas of type 2, two frames of face images have the gazing areas of type 5, and one frame of face image has the gazing area of type 12, where the ratio of the line of sight of the driver falling in gazing area No. 1 is 40%, the ratio of the line of sight of the driver falling in gazing areas 2, 3, 4, 6, and 7 is 30%, and the ratio of the line of sight of the driver falling in gazing areas 5, 8, 9, 10, 11, and 12 is 30%, in which case it is determined that the attention monitoring result of the driver is the distracted driving. In other possible implementations, if the type distribution of the gazing areas within one sliding time window simultaneously meets two or three distracted driving situations, the attention monitoring result can further include the corresponding distracted driving level. According to some embodiments, the distracted driving level is positively correlated to the number of types in the type distribution of the gazing areas that meet the distracted driving situations.

In addition, the attention monitoring result of the driver can further be determined according to the type distribution of gazing areas of the frames of face images included within multiple consecutive sliding time windows. In some possible implementations, referring to FIG. 2, during most time in normal driving, the line of sight of the driver is in gazing area No. 2, and due to the need to observe road conditions and vehicle conditions, the line of sight of the driver should also appear in gazing areas No. 2, 3, 4, 6, and 7. Therefore, if the line of sight of the driver keeps in gazing area No. 1 for a quite long period of time, it is apparently in a non-normal driving state. Therefore, a first threshold is set, and when the duration of the line of sight of the driver in gazing area No. 1 reaches the first threshold, it is determined that the attention monitoring result of the driver is the distracted driving. Since the size of the sliding time window is less than the first threshold, whether the duration of the line of sight of the driver in gazing area No. 1 reaches the first threshold is determined according to the type distribution of the gazing areas within multiple consecutive sliding time windows.

In the embodiments of the present disclosure, the in-vehicle/out-vehicle space area is divided into different areas according to actual requirements (such as models, user preferences, and both models and user preferences), so as to obtain different types of gazing areas; based on the face image of the driver captured by the camera, the type of the gazing area of the driver in the face image can be determined; and continuous attention monitoring for the driver is achieved by means of the type distribution of the gazing areas within the sliding time window. In the solution, the attention of a driver is monitored according to the type of a gazing area of the driver, which facilitates achieving forward targeted or full-space attention monitoring for the driver, thereby improving precision of attention monitoring for the driver; and accuracy of a monitoring result is further improved in combination with the type distribution of gazing areas within a sliding time window.

Referring to FIG. 3, FIG. 3 is a schematic flowchart of a possible implementation of step 102 in a driver attention monitoring method provided in embodiments of the present disclosure.

In 301, line of sight and/or head pose detection is performed on multiple frames of face images of a driver in a driving area included in a video.

In the embodiments of the present disclosure, the line of sight and/ or head pose detection includes: line of sight detection, head pose detection, and both line of sight detection and head pose detection.

Line of sight detection and head pose detection are performed on face images of the driver by means of a pre-trained neural network, so that line of sight information and/or head pose information can be obtained, where the line of sight information includes a line of sight and a start point position of the line of sight. In a possible implementation, the face images of the driver are subjected to convolution processing, normalization processing, and linear transformation in sequence to obtain the line of sight information and/or the head pose information.

For example, the face images of the driver can be subjected to driver face confirmation, eye area determination, and iris center determination in sequence, so as to achieve line of sight detection and line of sight information determination. In some possible implementations, since the profile of the eye of a person during head-up or look-up is larger than that during look-down, first, look-down is distinguished from head-up and look-up according to a pre-measured size of the orbit. Then, look-up and head-up are distinguished by using a difference in ratio of the distance from the upper orbit to the center of the eye during look-up and head-up; and the problem in looking to the left, the center, or the right is then handled. The ratio of the sum of squares of the distances from all pupil points to the left edge of the orbit to the sum of squares of the distances from all pupil points to the right edge is calculated, and the line of sight information during looking to the left, the center, or the right is determined according to the ratio.

For example, a head pose of the driver can be determined by processing the face image of the driver. In some possible implementations, facial feature points (such as mouth, nose, and eyes) are extracted from the face image of the driver, positions of the facial feature points in the face image are determined based on the extracted facial feature points, and then the head pose of the driver in the face image is determined according to relative positions between the facial feature points and the head.

For example, the line of sight and the head pose can be detected simultaneously, so as to improve detection precision. In some possible implementations, a sequential image of eye movement is captured by means of a camera arranged on a vehicle, the sequential image is compared with an eye image during head-up, an eyeball rotation angle is obtained according to a difference in comparison, and a line of sight vector is determined based on the eyeball rotation angle. Here, a detection result is obtained in the case of assuming that the head does not move. When the head slightly rotates, a coordinate compensation mechanism is first established to adjust the eye image during head-up. However, when the head largely deflects, the changing position and direction of the head relative to a fixed coordinate system in space is first observed, and the line of sight vector is then determined.

It can be understood that the above is an example of line of sight and/or head pose detection provided in the embodiments of the present disclosure. In specific implementations, a person skilled in the art can further perform line of sight and/or head pose detection with other methods. No limitation is made in the present disclosure.

In 302, the type of the gazing area of the driver in each frame of face image is determined according to the line of sight and/or head pose detection result for the frame of face image.

In the embodiments of the present disclosure, the line of sight detection result includes the line of sight vector of the driver in each frame of face image and a start position of the line of sight vector, and the head pose detection result includes the head pose of the driver in each frame of face image, where the line of sight vector can be understood as the direction of the line of sight, and a deflection angle of the line of sight of the driver in the face image relative to the line of sight of the driver during head-up can be determined according to the line of sight vector; and the head pose can be an Euler angle of the head of the driver in a coordinate system, where the foregoing coordinate system may be: a world coordinate system, a camera coordinate system, an image coordinate system, etc.

A gazing area classification model is trained by taking the line of sight and/or head pose detection result including gazing area type labeling information as a training set, such that the trained classification model can determine the type of the gazing area of the driver according to the line of sight and/or head pose detection result, where the foregoing gazing area classification model may be: a decision tree classification model, a selection tree classification model, a softmax classification model, etc. In some possible implementations, the line of sight detection result and the head pose detection result are both feature vectors. The line of sight detection result and the head pose detection result are subjected to fusion processing, and the gazing area classification model then determines the type of the gazing area of the driver according to the fused features. According to some embodiments, the foregoing fusion processing may be feature splicing. In other possible implementations, the gazing area classification model can determine the type of the gazing area of the driver based on the line of sight detection result or the head pose detection result.

In-vehicle environments and approaches of gazing area type division of vehicles in different models may be different. In the embodiments, a classifier for gazing area classification is trained by using a training set corresponding to a model, and the trained classifier is applicable to different models, where the training set corresponding to a model refers to the line of sight and/or head pose detection result including gazing area type labeling information of the model and labeling information of the type of a gazing area of a corresponding new model, and the classifier to be used in the new model is subjected to supervised training based on the training set. The classifier can be pre-constructed based on a neural network, a support vector machine, etc. The specific structure of the classifier is not limited in the present disclosure.

For example, in some possible implementations, a forward space of model A relative to the driver is divided into twelve gazing areas, and according to vehicle space features of model B, a forward space of model B relative to the driver needs to be divided into gazing areas different from those of model A, such as ten gazing areas. In that situation, a driver attention monitoring technical solution constructed based on the embodiments is applied to model A; and before the attention monitoring technical solution needs to be applied to model B, the line of sight and/or head pose detection technology in model A can be reused, and gazing areas are re-divided just according to the space features of model B. The training set is constructed based on the line of sight and/or head pose detection technology and the gazing area division corresponding to model B, where the face image included in the training set includes the line of sight and/or head pose detection result and the gazing area type labeling information corresponding to the corresponding model B. As a result, the classifier for gazing area classification of model B is subjected to supervised training based on the constructed training set, without performing repeated training on the model for line of sight and/or head pose detection. The trained classifier and the reused line of sight and/or head pose detection technology constitute the driver attention monitoring solution provided in the embodiments of the present disclosure.

In the embodiments, feature information detection (such as line of sight and/ or head pose detection) required for gazing area classification and gazing area classification performed based on foregoing feature information are divided into two relatively independent stages, thereby improving reusability of feature information detection technologies such as line of sight and/or head pose detection in different models. For a new application scene (such as a new model) that requires change in gazing area division, it only needs to make corresponding adjustment to adapt to a new classifier or classification method for gazing area division, thereby reducing the complexity and computational amount of adjusting the driver attention detection technical solution in the new application scene that requires change in gazing area division, improving the universality and generalization of the technical solution, and thus better meeting diverse practical application requirements.

In addition to dividing the feature information detection required for gazing area classification and gazing area classification based on foregoing feature information into two relatively independent stages, the embodiments of the present disclosure can also implement peer-to-peer gazing area type detection based on a neural network, i.e., inputting the face image into the neural network, and outputting a detection result for a gazing area type after processing the face image by the neural network. The neural network may be stacked or composed in a certain manner based on network units such as a convolutional layer, a non-linear layer, and a Fully Connected (FC) layer, or may use an existing neural network structure. No limitation is made thereto in the present disclosure. After a neural network structure to be trained is determined, the neural network can be subjected to supervised training by using a face image set including the gazing area type labeling information, or the neural network can be subjected to supervised training by using a face image set including gazing area type labeling information and an eye image cropped based on each face image in the face image set; and the gazing area type labeling information includes one of multiple types of defined gazing areas. The neural network is subjected to supervised training based on the face image set having the foregoing labeling information, so that the neural network can learn a feature extraction capability and a gazing area classification capability required for gazing area division at the same time, thereby achieving peer-to-peer detection including inputting an image and outputting a gazing area type detection result.

Referring to FIG. 4, FIG. 4 is a schematic flowchart of one implementation of a training method for a neural network for gazing area type detection provided in embodiments of the present disclosure.

In 401, a face image set including gazing area type labeling information is obtained.

In the embodiments, each frame of image in the face image set includes a gazing area type. Taking gazing area type division in FIG. 2 as an example, the labeling information included in each frame of image is any number from 1 to 12.

In 402. an image in the face image set is subjected to feature extraction processing to obtain a fourth feature.

The face image is subjected to feature extraction processing by means of a neural network to obtain the fourth feature. In some possible implementations, the face image is subjected to convolution processing, normalization processing, first linear transformation, and second linear transformation in sequence to achieve feature extraction processing to obtain the fourth feature.

First, the face image is subjected to convolution processing by means of multiple convolutional layers in the neural network to obtain a fifth feature, where feature content and semantic information extracted by each convolutional layer are different. Specifically, convolution processing of the multiple convolutional layers abstracts image features step by step, and will also gradually remove relatively minor features. Therefore, the smaller the size of the feature extracted later, the more concentrated the content and semantic information. The face image is subjected to a convolution operation step by step by means of the multiple convolutional layers, and corresponding intermediate features are extracted to finally obtain feature data of a fixed size. In this way, the image size can be reduced, the computational amount of the system can be reduced, and the computational speed can be increased while obtaining main content information of the face image (i.e., feature data of the face image). An implementation process of the foregoing convolution processing is as follows: the convolutional layers perform convolution processing on the face image, i.e., sliding a convolution kernel on the face image, multiplying a pixel value on a face image point and a value on the corresponding convolution kernel, then adding all products as a pixel value on the image corresponding to the middle pixel of the convolution kernel, and finally, processing all pixel values in the face image by sliding, and extracting the fifth feature. It should be understood that the number of the foregoing convolutional layers is not specifically limited in the present disclosure.

During the convolution processing on the face image, a distribution of data will change after the data is processed by each layer of the network, which will cause difficulty in extraction of the next layer of the network. Therefore, before performing subsequent processing on the fifth feature obtained by means of the convolution processing, it is necessary to perform normalization processing on the fifth feature, i.e., normalizing the fifth feature to a normal distribution having a mean of 0 and a variance of 1. In some possible implementations, a normalization processing (batch norm, BN) layer is connected following the convolutional layers. The BN layer performs normalization processing on features by adding trainable parameters, which can speed up training, eliminate data correlation, and highlight a difference in distribution between features. In one example, a processing process for the fifth feature by the BN layer is described below:

Assuming the fifth feature β=x_{1→m}, where m pieces of data is included in total, and an output yᵢ=BN(x), then the BN layer performs the following operations on the fifth feature:

first, calculating a mean of the fifth feature

$$β = {x}_{1 \to m} , i . e . , {μ}_{β} = \frac{1}{m} {¡}_{i = 1}^{m} {x}_{i} ;$$

determining, according to the mean μ_{α}, a variance of the fifth feature, i.e.,

$${σ}_{β}^{2} = \frac{1}{m} {Σ}_{i = 1} {m ( {x}_{i} - {μ}_{β} )}^{2} ;$$

performing normalization processing on the fifth feature according to the mean μ_{β} and the variance σ_{β}² to obtain xᵢ⁻; and

finally, obtaining a normalization result based on a scaling variable γ and a translation variable δ, i.e., yᵢ=γxᵢ⁻, where γ and δ are known.

Due to the small capability of convolution processing and normalization processing to learn complex mappings from data, it is impossible to learn and process complex data, such as images, videos, audios, and speeches. Therefore, it is necessary to solve complex problems such as image processing and video processing by linearly transforming the normalized data. A linear activation function is connected following the BN layer, and the normalized data is linearly transformed by means of the activation function, thereby processing complex mappings. In some possible implementations, the normalized data is substituted into a linear rectification function (rectified linear unit, ReLU) so as to achieve the first linear transformation of the normalized data to obtain a sixth feature.

An FC layer is connected following the activation function layer, and the sixth feature is processed by means of the FC layer, so as to map the sixth feature to a sample (i.e., gazing area) labeling space. In some possible implementations, the sixth feature is subjected to the second linear transformation by means of the FC layer. The FC layer includes an input layer (i.e., the activation function layer) and an output layer, and any neuron of the output layer is connected to every neuron of the input layer, where each neuron in the output layer has a corresponding weight and bias. Therefore, all parameters of the FC layer are the weight and bias of each neuron, and the specific values of the weight and bias are obtained by training the FC layer.

When the sixth feature is input to the FC layer, the weight and bias of the FC layer (i.e., the weight of second feature data) are obtained, and then the sixth feature is weighted and summed according to the weight and offset to obtain the fourth feature. In some possible implementations, the weight and bias of the FC layer are respectively wᵢ and bᵢ, where i is the number of neurons and the sixth feature is x, and the FC layer performs the second linear transformation on third feature data to obtain first feature data

$${\sum }_{i = 1}^{i} ( {w}_{i} x + {b}_{i} ) .$$

In 403, the first feature data is subjected to first con-linear transformation to obtain a gazing area type detection result.

A softmax layer is connected following the FC layer, input different feature data is mapped as values from 0 to 1 by means of a built-in softmax function of the softmax layer, the sum of all values after mapping is 1, and the values after mapping have one-to-one correspondence to the input features. In this way, prediction for each feature data is completed, and a corresponding probability is given in the form of a value. In a possible implementation, the fourth feature is input to the softmax layer, and the fourth feature is substituted into the softmax function to perform the first non-linear transformation to obtain probabilities that the line of sight of the driver is in different gazing areas.

In 40, a network parameter of the neural network is adjusted according to a difference between the gazing area type detection result and the gazing area type labeling information.

In the embodiments, the neural network includes a loss function, and the loss function may be: a cross entropy loss function, a mean variance loss function, a square loss function, etc. The specific form of the loss function is not limited in the present disclosure.

Each image in the face image set has corresponding labeling information, i.e., each face image corresponds to a gazing area type. The probabilities for different gazing areas obtained in 402 and the labeling information are substituted into the loss function to obtain a loss function value. The loss function value is less than or equal to a second threshold by adjusting the network parameter of the neural network, thereby completing training of the neural network, where the foregoing network parameter includes the weight and bias of each network layer in 401 and 402.

In the embodiments, a neural network is trained according to a face image set including gazing area type labeling information, and the trained neural network can determine the type of a gazing area based on an extracted face image feature. According to the training method provided in the embodiments, it only needs to input the face image set to obtain the trained neural network. The training method is simple and the training time is short.

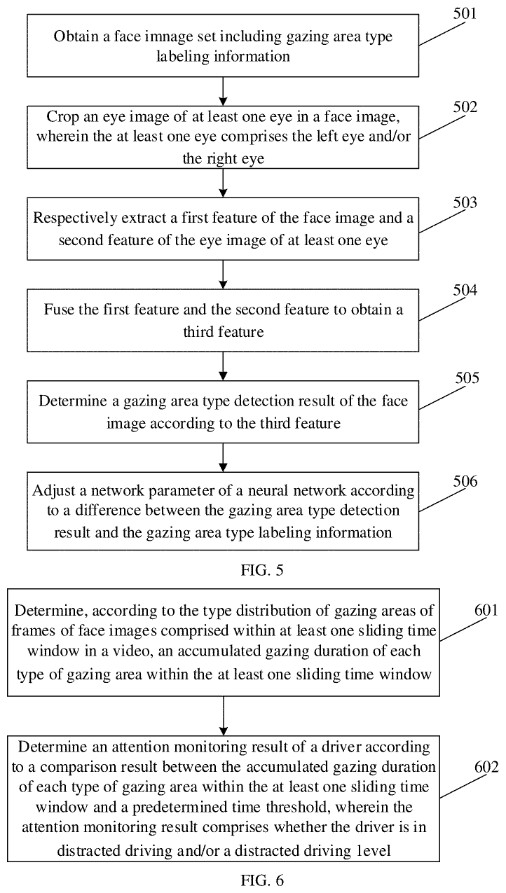

Referring to FIG. 5, FIG. 5 is a schematic flowchart of another implementation of a training method for a neural network provided in embodiments of the present disclosure.

In 501, a face image including gazing area type labeling information in a face image set is obtained.

In the embodiments, each image in the face image set includes a gazing area type. Taking gazing area type division in FIG. 2 as an example, the labeling information included in each frame of image is any number from 1 to 12.

Features at different scales are fused to enrich feature information, such that the gazing area type detection precision can be improved. Refer to 502-505 for an implementation process of enriching the foregoing feature information.

In 502,. an eye image of at least one eye in the face image is cropped, where the at least one eye includes the left eye and/or the right eye.

The left eye and/or the right eye includes: the left eye, the right eye, or both the left eye and the right eye.

In the embodiments, an eye area image is identified from the face image, or the eye area image is cropped from the face image by means of screenshot software, or the eye area image can also be cropped from the face image by means of drawing software. The specific implementations of how to identify the eye area image from the face image and how to crop the eye area image from the face image are not limited in the present disclosure.

In 503, a first feature of the face image and a second feature of the eye image of the at least one eye are respectively extracted.

In the embodiments, a trained neural network includes multiple feature extraction branches, and second feature extraction processing is performed on the face image and the eye image by means of different feature extraction branches to obtain the first feature of the face image and the second feature of the eye image, thereby enriching extracted image feature scales. In some possible implementations, the face image is respectively subjected to convolution processing, normalization processing, third linear transformation, and four linear transformation in sequence by means of the different feature extraction branches to obtain the face image feature and the eye image feature, where line of sight vector information includes a line of sight vector and a start point position of the line of sight vector. It should be understood that the foregoing eye image may include only one eye (the left eye or the right eye), and may also include two eyes. No limitation is made thereto in the present disclosure.

For specific implementation processes of the foregoing convolution processing, normalization processing, third linear transformation, and fourth linear transformation, refer to the convolution processing, normalization processing, first linear transformation, and second linear transformation in step 402. Details are not described herein again.

In 504, the first feature and the second feature are fused to obtain a third feature.

Since features at different scales of the same object (i.e., the driver in the embodiment) include different scene information, features with more information can be obtained by fusing the features at different scales.

In some possible implementations, feature information of multiple features is fused into one feature by performing fusion processing on the first feature and the second feature, thereby facilitating improving the driver gazing area type detection precision.

In 505, a gazing area type detection result of the face image is determined according to the third feature.

In the embodiments, the gazing area type detection result refers to probabilities that a line of sight of the driver is in different gazing areas, and the values range from 0 to 1. In some possible implementations, the third feature is input to a softmax layer, and the third feature is substituted into a softmax function to perform second non-linear transformation to obtain probabilities that the line of sight of the driver is in different gazing areas.

In 506, a network parameter of the neural network is adjusted according to a difference between the gazing area type detection result and the gazing area type labeling information.

In the embodiments, the neural network includes a loss function, and the loss function may be: a cross entropy loss function, a mean variance loss function, a square loss function, etc. The specific form of the loss function is not limited in the present disclosure.

The probabilities for different gazing areas obtained in 505 and the labeling information are substituted into the loss function to obtain a loss function value. The loss function value is less than or equal to a third threshold by adjusting the network parameter of the neural network, thereby completing training of the neural network, where the foregoing network parameter includes the weight and bias of each network layer in 503 to 505.

A neural network trained with the training method provided in the embodiments can fuse features at different scales extracted from the same frame of image to enrich feature information, and then the type of a gazing area of a driver is identified based on the fused features to improve identification precision.

It should be understood by a person skilled in the art that two training methods for the neural network provided in the present disclosure (401-404 and 501-506) can be implemented on a local terminal (such as a computer or a mobile phone or an on-board unit), and can also be implemented by means of a cloud terminal. No limitation is made thereto in the present disclosure.

Referring to FIG. 6, FIG. 6 is a schematic flowchart of a possible implementation of step 103 in a driver attention monitoring method provided in embodiments of the present disclosure.

In 601, an accumulated gazing duration of each type of gazing area within at least one sliding time window is determined according to the type distribution of gazing areas of the frames of face images included within the at least one sliding time window in a video.

During driving, the longer the duration of the line of sight of a driver in gazing areas other than a left front windshield area (refer to FIG. 2 if a cab is on the left side of a vehicle), the higher the probability that the driver is in distracted driving, and the higher a distracted driving level. Therefore, an attention monitoring result for the driver can be determined according to the duration of the line of sight of the driver in the gazing area. Since the line of sight of the driver may switch among different gazing areas during a vehicle driving process, the type of the gazing area will change accordingly. Apparently, it is unreasonable to determine the attention monitoring result according to an accumulated duration of the line of sight of the driver in the gazing area or to determine the attention monitoring result according to a continuous duration of the line of sight of the driver in the gazing area. Therefore, the attention of the driver is monitored by means of the sliding time window to achieve continuous monitoring for the attention of the driver. First, the accumulated duration of each gazing area within a sliding time window is determined according to the type of the gazing area of each frame of face image within the sliding time window and the duration of each frame of face image. In some possible implementations, taking gazing area type division in FIG. 2 as an example, among ten frames of face images within one sliding time window, four frames of face images have the gazing areas of type 1, three frames of face images have the gazing areas of type 2, two frames of face images have the gazing areas of type 5, and one frame of face image has the gazing area of type 12; and if the duration of one frame of face image is 0.4 second, within the sliding time window, the accumulated duration of gazing area No. 1 is 1.6 seconds, the accumulated duration of gazing area No. 2 is 1.2 seconds, the accumulated duration of gazing area No. 5 is 0.8 second, and the accumulated duration of gazing area No. 12 is 0.4 second.

In 602, the attention monitoring result of the driver is determined according to a comparison result between the accumulated gazing duration of each type of gazing area within the at least one sliding time window and a predetermined time threshold, where the attention monitoring result includes whether the driver is in distracted driving and/or the distracted driving level.

In the embodiments of the present disclosure, the distracted driving and/or the distracted driving level include: distracted driving, distracted driving level, or both distracted driving and distracted driving level.

As stated above, due to the need of driving, there may be multiple gazing area types for the driver within a certain period of time, and apparently, the probabilities of distracted driving corresponding to different gazing areas are different. Taking FIG. 2 as an example, when the gazing area of the driver is 1, the probability of distracted driving of the driver is small, and when the gazing area of the driver is 10, the probability of distracted driving of the driver is large. Therefore, different time thresholds are set for different types of gazing areas to reflect that when the line of sight of the driver is in different types of gazing areas, the probabilities of distracted driving of the driver are different. Then, the attention monitoring result of the driver is determined according to the comparison result between the accumulated gazing duration of each type of gazing area within at least one sliding time window and a respective time threshold of the type of defined gazing area. In that case, each sliding time window corresponds to one attention monitoring result.

According to some embodiments, when the accumulated duration of the line of sight of the driver in any gazing area within one sliding time window reaches the time threshold of the gazing area, it is determined that an attention detection result of the driver is the distracted driving. In some possible implementations, taking FIG. 2 as an example, the duration of a sliding time window is set to be 5 seconds. When the driver needs to observe the road condition in the right front, the line of sight will be in gazing area 2; during the driving process, when the driver needs to know a real-time condition of the vehicle by observing data displayed on a dashboard, the line of sight will be in gazing area 3; during normal driving, the line of sight of the driver should not appear in gazing area 10. Therefore, the time thresholds of gazing areas 2, 3, and 10 can be set to be 2.5 seconds, 1.5 seconds, and 0.7 second, respectively. If it is detected that within one sliding time window, the accumulated durations in gazing areas 2, 3, and 10 of the driver are 1.8 seconds, 1 second, and 1 second, respectively, the attention detection result of the driver is the distracted driving. It should be understood that the size of the sliding time window and the value of the time threshold of the gazing area can be adjusted according to actual use conditions. No specific limitation is made thereto in the present disclosure.

According to some embodiments, the attention monitoring result further includes the distracted driving level, i.e., when the attention monitoring results within multiple consecutive sliding time windows are all the distracted driving, the corresponding distracted driving level will increase accordingly. For example, if the attention monitoring result within any one sliding time window is the distracted driving, the corresponding distracted driving level is 1, and if the attention monitoring results within two continuous sliding time windows are the distracted driving, the corresponding distracted driving level is 2.

According to some embodiments, multiple cameras may be arranged in different places inside the vehicle, or multiple cameras may be arranged in different places outside the vehicle, or multiple cameras may be arranged in different places both inside and outside the vehicle. Multiple face images at the same time can be obtained by means of the foregoing multiple cameras. Once each frame of face image is processed, the gazing area corresponds to a type. In this case, the type of the gazing area of the driver is determined in combination of the type of the gazing area of each frame of image. Therefore, the embodiments of the present disclosure provide a “majority rule”-based voting method to determine the type of the gazing area, thereby improving reliability of gazing area type detection and further improving accuracy of driver attention detection. The method includes the following steps:

respectively capturing, by multiple cameras respectively arranged on multiple areas on a vehicle, videos of a driving area from different angles;

respectively detecting, for multiple frames of face images of a driver in the driving area included in each of the multiple captured videos, gazing area types of the driver in the frames of face images aligned in time; and

determining a majority of obtained gazing area types as the gazing area type of the face images at that time.

In the embodiments, the frames of face images aligned in time among multiple videos refer to the frames of face images at the same time among videos captured by multiple cameras. In some possible implementations, three cameras, i.e., camera No. 1, camera No. 2, and camera No. 3, are arranged on the vehicle, and videos of the driving area can respectively be captured by the three cameras from different angles. The three cameras are respectively mounted in different positions of the vehicle to capture videos of the driving area from different angles, etc. For example, at the same time, the type of the gazing area corresponding to the face image captured by camera No. 1 is a right front windshield area, the type of the gazing area corresponding to the face image captured by camera No. 2 is an in-vehicle rearview mirror area, and the type of the gazing area corresponding to the face image captured by camera No. 3 is the right front windshield area. Since two of the three results indicate the right front windshield area, and only one result indicates the in-vehicle rearview mirror area, the gazing area of the driver that is finally output is the right front windshield area, and the type of the gazing area is 2.

According to some embodiments, light in the real environment is complicated, and light in the vehicle is even more complicated. Moreover, the light intensity will directly affect photography quality of the camera, and some useful information will lose in a low-quality image or video. In addition, different photography angles will also affect the quality of a photographed image, leading to problems such as an inconspicuous or obstructed feature in the video or image. For example, the camera fails to photograph the eyes of the driver clearly due to reflection of lenses of the glasses of the driver, or the image of the eye part fails to be photographed due to a head pose of the driver, which affects subsequent image-based detection processing. Therefore, the embodiments further provide selecting a high-quality image from images photographed from multiple angles as an image for driver gazing area type detection. Since the quality of the image serving as a detection basis is guaranteed, the accuracy of gazing area type detection is improved, solutions for scenes with different light environments, large angles of faces, or obstruction are provided, and the accuracy of driver attention monitoring is improved. The method includes the following steps:

respectively capturing, by multiple cameras respectively arranged on multiple areas on a vehicle, videos of a driving area from different angles;

respectively determining, according to an image quality evaluation index, an image quality score of each frame of face image in multiple frames of face images of a driver in the driving area included in each of the multiple captured videos;

respectively determining a face image having a highest image quality score among the frames of face images aligned in time in the multiple videos; and

respectively determining the type of the gazing area of the driver in each face image having the highest image quality score.

In the embodiments, the image quality evaluation index includes at least one of: whether an image includes an eye image, a definition of an eye area in an image, a shielding status of an eye area in an image, or an eye opening/closing status of an eye area in an image; and the frames of face images aligned in time among multiple videos refer to the frames of face images at the same time among videos captured by multiple cameras. The image determined by the image quality evaluation index can achieve more accurate detection of the gazing area of the driver in the image.

In some possible implementations, at the same time, cameras arranged in different places of the vehicle respectively obtain images including the face of the driver from different angles, and score the quality of all the images according to the foregoing image quality evaluation index. For example, 5 points are obtained if an image includes the eye image, a corresponding score ranging from 1 to 5 is obtained according to the definition of the eye area in the image, and finally, the two scores are added to obtain the image quality score. The image having the highest image quality score among multiple frames of images captured by cameras from different angles at the same time is taken as a to-be-processed image for determining the gazing area type at that time, and the type of the gazing area of the driver in the to-be-processed image is determined. It should be understood that the determination of the definition of the eye area in the image can be implemented by any image definition algorithm, such as a gray variance function, a gray variance product function, and an energy gradient function. No specific limitation is made thereto in the present disclosure.

In the embodiments, whether the driver is in the distracted driving is determined according to the comparison result between the accumulated gazing duration of each type of gazing area within the sliding time window and the predetermined time threshold; the distracted driving level is determined according to the number of sliding time windows; videos of the driving area are captured from different angles by cameras arranged on different areas on the vehicle so as to improve image quality of the captured face image, and the face image having the highest image quality is determined by means of the image quality evaluation index, where the determination of the attention monitoring result based on the face image having the highest image quality can improve monitoring precision; in the case that multiple cameras are arranged on the vehicle, the attention monitoring result is also determined from multiple attention monitoring results corresponding to multiple cameras at the same time according to the “majority rule”, where detection precision can also be improved.

In the case of determining that the driver is in the distracted driving, the driver can be promptly prompted to concentrate on driving. The following embodiment is a possible implementation of distracted driving prompting provided in the present disclosure.

In the case that the attention monitoring result of the driver is the distracted driving, the driver can be given a corresponding prompt for distracted driving to concentrate on driving. The prompt for distracted driving includes at least one of: a text prompt, a voice prompt, a smell prompt, or a low-current stimulation prompt.

In some possible implementations, upon detection that the attention monitoring result of the driver is the distracted driving, a dialog box pops up on a Head Up Display (HUD) to prompt and warn the driver; the driver can also be prompted and warned by means of built-in voice data of a vehicle-mounted terminal, such as “please concentrate on driving”; gas having a refreshing effect can be released, such as spraying floral water by means of a vehicle-mounted nozzle, where the smell of the floral water is pleasant so that the refreshing effect can be yielded whiling prompting and warning the driver; further, low current can be discharged by means of a seat to stimulate the driver to achieve the effects of prompting and warning.

The embodiments provide several distracted driving prompting modes to implement effective prompting and warning for the driver in the case that the driver is in the distracted driving.

The following embodiment is another possible implementation of distracted driving prompting provided in the present disclosure.

As stated above, when the attention monitoring results within multiple consecutive sliding time windows are all the distracted driving, the corresponding distracted driving level will also be increased accordingly. In the case that the attention monitoring result of the driver is the distracted driving, the distracted driving level of the driver is determined according to a preset mapping relationship between the distracted driving level and the attention monitoring result and to the attention monitoring result of the driver; and a prompt is determined from prompts for distracted driving according to a preset mapping relationship between the distracted driving level and the prompt for distracted driving and to the distracted driving level of the driver to give the driver the prompt for distracted driving, where the preset mapping relationship between the distracted driving level and the attention monitoring result includes: in the case that the monitoring results within multiple consecutive sliding time windows are all the distracted driving, the distracted driving level is positively correlated to a number of the sliding time windows.

In some possible implementations, refer to Table 1 for a mapping relationship among the number of sliding time windows, the distracted driving level, and the prompting mode.

TABLE 1

| Number of Sliding | Distracted | |
|---|---|---|
| Time Windows | Driving Level | Prompting Mode |
| 1 | 1 | Smell prompt |
| 2 or 3 | 2 | Text prompt |
| 4 or 5 | 3 | Voice prompt |
| 6 to 8 | 4 | Low-current stimulation prompt |
| Greater than | 5 | Voice prompt and low-current |
| or equal to 9 | | stimulation prompt |

When the attention monitoring result within any one sliding time window is the distracted driving, it is determined that the distracted driving level of the driver is 1, in which case the driver is prompted and warned by means of the smell prompt, for example, releasing gas having the refreshing effect, such as spraying floral water by means of the vehicle-mounted nozzle; when the attention monitoring results within 2 or 3 continuous sliding time windows is the distracted driving, it is determined that the distracted driving level of the driver is 2, in which case the driver is prompted and warned by means of the text prompt, for example, popping up the dialog box on the HUD to prompt and warn the driver; when the attention monitoring results within 4 or 5 continuous sliding time windows are the distracted driving, it is determined that the distracted driving level of the driver is 3, in which case the driver is prompted and warned by means of the voice prompt, for example, the vehicle-mounted terminal issues a prompting sentence “please concentrate on driving”; when the attention monitoring results within 6 to 8 continuous sliding time windows are the distracted driving, it is determined that the distracted driving level of the driver is 4, in which case the driver is prompted and warned by means of the low-current stimulation prompt, for example, discharging low current from the seat of the driver to stimulate the driver; when the attention monitoring results within 9 or more continuous sliding time windows are the distracted driving, it is determined that the distracted driving level of the driver is 5, in which case the driver is given the voice prompt and the low-current stimulation prompt at the same time, so as to prompt the driver to concentrate on driving.

In the embodiments, the distracted driving level of the driver is determined according to the mapping relationship among the number of sliding time windows, the distracted driving level, and the prompting mode, and different degrees of prompts are given to prompt the driver in time in a reasonable mode, thereby making the driver concentrate on driving and thus preventing traffic accidents caused by distracted driving of the driver.

After the attention monitoring result of the driver is determined, the attention monitoring result of the driver can be analyzed, for example, determining a driving habit of the driver according to the attention monitoring result of the driver, and giving the cause of distracted driving. The attention monitoring result can also be sent to a server or a terminal; and the relevant personnel can remotely control the vehicle by means of the server or the terminal, or learn a driving status of the driver based on the attention monitoring result and perform corresponding processing based on the driving status of the driver. The following embodiments are some possible implementations based on the attention monitoring result provided in the present disclosure.

The vehicle may establish a communicational connection with the server or the terminal, where the foregoing communicational connection may be a cellular network connection, a Near Field Communication (NFC) connection, a Bluetooth connection, etc. No limitation is made to the communicational connection mode in the present disclosure. In the case that the attention monitoring result of the driver is determined, the attention monitoring result of the driver is sent to the server or the terminal that is communicationally connected to the vehicle, so that the relevant personnel on the server side and a user on the terminal side can learn the attention monitoring result of the driver in real time.

In some possible implementations, the relevant personnel of a logistics company can obtain the attention monitoring result of each driver in real time by means of the server, and can also collect statistics about the attention monitoring result of the driver stored in the server and then manage the driver according to the statistical result. In some possible implementations, logistics company C stipulates that the attention monitoring result of the driver in a logistics transportation process is taken as one of assessment criteria for the driver. For example, in any logistics transportation process, if the accumulated time of distracted driving accounts for 5% or more of a total logistics transportation time, an assessment score is reduced by 1 point; if the accumulated time of distracted driving accounts for 7% or more of the total logistics transportation time, the assessment score is reduced by 2 points; if the accumulated time of distracted driving accounts for 10% or more of the total logistics transportation time, the assessment score is reduced by 3 points; if the accumulated time of distracted driving accounts for 3% or less of the total logistics transportation time, the assessment score is added by 1 point; if the accumulated time of distracted driving accounts for 2% or less of the total logistics transportation time, the assessment score is added by 2 points; and if the accumulated time of distracted driving accounts for 1% or less of the total logistics transportation time, the assessment score is added by 3 points. For another example, each time the distracted driving at level 1 happens, the assessment score is reduced by 0.1 point; each time the distracted driving at level 2 happens, the assessment score is reduced by 0.2 point; each time the distracted driving at level 3 happens, the assessment score is reduced by 0.3 point; each time the distracted driving at level 4 happens, the assessment score is reduced by 0.4 point; and each time the distracted driving at level 5 happens, the assessment score is reduced by 0.5 point.

Further, a fleet can be managed based on management for the driver. In other possible implementations, logistics company C can rate the driver according to the assessment score of the driver. The higher the assessment score, the higher the rating. Apparently, the higher the rating of the driver, the better the driving habit of the driver, where the driving habit may indicate non-distracted driving, non-fatigue driving, etc.; moreover, in logistics company C, a transportation task having the higher priority can be preferentially assigned to the driver having the higher rating. Therefore, the transportation task can be successfully completed, and the driver can be also convinced of the arrangement of the company.

The vehicle is connected to a mobile terminal (such as a mobile phone, a tablet computer, a laptop computer, and a wearable device) of another person (anyone except the driver) in the vehicle by means of NFC or Bluetooth, and the attention monitoring result of the driver is sent to the mobile terminal in real time so that the another person in the vehicle can prompt the driver when the driver is in distracted driving. In some possible implementations, the husband is the driver, the wife sits in a front passenger seat and is watching a movie with the tablet computer, and the wife learns, from a message popping up on the tablet computer, that the husband is in distracted driving and the distracted driving level has reached 3. In this case, the wife can put down the tablet computer in the hand and give the husband a verbal prompt, such as “where do you look? Concentrate on driving!”, so that the husband is prompted and warned and can then concentrate on driving. The approach of displaying the attention monitoring result of the driver by means of the terminal is not limited to the foregoing “pop-up”, but can also be the voice prompt, dynamic effect display, etc. No limitation is made thereto in the present disclosure. It should be understood that in the implementation, another person in the vehicle can artificially determine, in combination with factors such as the attention monitoring result, road conditions, and vehicle conditions, whether the driver needs to be prompted or what degree of prompting needs to be given to the driver. Apparently, in most cases, a human determination capability is better than that of a machine. Therefore, the effect of giving the driver the prompt by another person in the vehicle is better than that of the prompting modes in Table 1.

The attention monitoring result of the driver is sent to a terminal communicationally connected to the vehicle over a cellular network, where the terminal can be a mobile terminal or a non-mobile terminal, and a user of the terminal can be the family of the driver or a trusted person of the driver. No limitation is made thereto in the present disclosure. The user of the terminal can take corresponding measures according to the attention monitoring result of the driver, so as to prevent traffic accidents. In some possible implementations, the father at home learns, by means of the mobile phone, that the son serving as the driver is driving distractedly, the distracted driving level has reached 5, and the number of sliding time windows within which the attention monitoring results are the distracted driving has been increasing. Apparently, the driving status of the driver is extremely abnormal, and is very prone to cause a traffic accident. In this case, the father can call the daughter-in-law who sits in the front passenger seat and is watching a movie, and let her prompt the son, or take other measures to reduce potential safety risks.

According to some embodiments, a control instruction, such as switching a driving mode, adjusting an alarm mode, and both switching the driving mode and adjusting the alarm mode, may also be sent to the vehicle by means of the terminal. Upon receipt of the control instruction sent by the server or the terminal, the vehicle is controlled according to the control instruction. In some possible implementations, the control instruction is sent to the vehicle by means of a remote control terminal of the vehicle to switch the driving mode of the vehicle from a non-automatic driving mode to an automatic driving mode, so that the vehicle is in an automatic driving mode, thereby reducing potential safety risks caused by unsafe driving of the driver. In other possible implementations, the control instruction is sent to the vehicle by means of the remote control terminal of the vehicle, so as to adjust the alarm mode of the vehicle (such as increasing the volume of an alarm on the vehicle) to enhance the alarm effect, thereby reducing potential safety risks. In yet some possible implementations, the control instruction is sent to the vehicle by means of the remote control terminal of the vehicle, so as to switch the driving mode of the vehicle from the non-automatic driving mode to the automatic driving mode and adjust the alarm mode of the vehicle.

The vehicle-mounted terminal can also perform statistical analysis on the attention detection result of the driver to obtain an analysis result, such as the time when distracted driving happens, the amount of distracted driving, the accumulated time of distracted driving, the level of each distracted driving, and driving habit information of the driver, where the driving habit information includes the type distribution of gazing areas during distracted driving, and the cause of distracted driving. In some possible implementations, the vehicle-mounted terminal collects statistics about the attention monitoring result of the driver to obtain the type distribution of gazing areas during distracted driving. For example, taking FIG. 2 as an example, within the past week, during distracted driving, the types of 50% gazing areas indicate area No. 12, the types of 30% gazing areas indicate area No. 7, the types of 10% gazing areas indicate area No. 2, and the types of 10% gazing areas indicate other areas. Further, the cause of distracted driving of the driver, such as talking with a passenger in the front passenger seat while driving, can be given according to the type distribution of gazing areas. The type distribution of gazing areas and the cause of distracted driving are presented to the driver in the form of a statistical report, so that the driver knows the driving habit in time and makes corresponding adjustment. According to some embodiments, the statistical result including the time when distracted driving happens, the amount of distracted driving, the accumulated time of distracted driving, and the level of each distracted driving may also be presented to the driver in the form of a report. By applying the embodiments, the attention monitoring result of the driver can be sent to the server and then stored, and relevant personnel can manage the driver by means of the attention monitoring result stored in the server; by sending the attention monitoring result of the driver to another terminal in the vehicle, another person in the vehicle can know the driving status of the driver in time and give the driver a corresponding prompt to prevent traffic accidents; by sending the attention monitoring result of the driver to the remote terminal, another person can perform corresponding control on the vehicle according to the attention monitoring result, thereby reducing potential safety risks. By analyzing the attention monitoring result of the driver, the driver can understand the driving status more clearly according to the analysis result and then correct the bad driving habit in time, thereby preventing traffic accidents.

A person skilled in the art can understand that, in the foregoing methods of the specific implementations, the order in which the steps are written does not imply a strict execution order which constitutes any limitation to the implementation process, and the specific order of executing the steps should be determined by functions and possible internal logics thereof.

Referring to FIG. 7, FIG. 7 is a schematic structural diagram of an apparatus for identifying distracted driving provided in embodiments of the present disclosure. The apparatus 1 includes: a first control unit 11, a first determination unit 12, a second determination unit 13, a prompting unit 14, a third determination unit 15, a fourth determination unit 16, a training unit 17, a sending unit 18, an analysis unit 19, and a second control unit 20.

The first control unit 11 is configured to capture, by a camera arranged on a vehicle, a video of a driving area of the vehicle; respectively arrange cameras at different angles on multiple areas on the vehicle, and respectively capture video streams of the driving area by multiple cameras; and respectively capture, by multiple cameras respectively arranged on multiple areas on the vehicle, videos of the driving area from different angles.

The first determination unit 12 is configured to determine, according to each of multiple frames of face images of a driver in the driving area included in the video, a type of a gazing area of the driver in the frame of face image, where the gazing area of the frame of face image is one of multiple types of defined gazing areas obtained by dividing a space area of the vehicle in advance; and respectively arrange cameras at different angles on multiple areas on the vehicle, respective capture video streams of the driving area by multiple cameras, and respectively detect gazing area types in face images at the same time among the captured multiple video streams.

The second determination unit 13 is configured to determine an attention monitoring result of the driver according to the type distribution of gazing areas of the frames of face images included within at least one sliding time window in the video.

The prompting unit 14 is configured to, in the case that the attention monitoring result of the driver is distracted driving, give the driver a prompt for distracted driving, where the prompt for distracted driving includes at least one of: a text prompt, a voice prompt, a smell prompt, or a low-current stimulation prompt.

The third determination unit 15 is configured to, in the case that the attention monitoring result of the driver is the distracted driving, determine a distracted driving level of the driver according to a preset mapping relationship between the distracted driving level and the attention monitoring result and to the attention monitoring result of the driver.

The fourth determination unit 16 is configured to determine, according to a preset mapping relationship between the distracted driving level and the prompt for distracted driving and to the distracted driving level of the driver, a prompt from among the prompts for distracted driving to give the driver the prompt for distracted driving.

The training unit 17 is configured to train a neural network.

The sending unit 18 is configured to send the attention monitoring result of the driver to a server or a terminal communicationally connected to the vehicle.

The analysis unit 19 is configured to perform statistical analysis on the attention monitoring result of the driver.

The second control unit 20 is configured to, after sending the attention monitoring result of the driver to the server or the terminal communicationally connected to the vehicle and in the case of receiving a control instruction sent by the server or the terminal, control the vehicle according to the control instruction.

In one possible implementation, the multiple types of defined gazing areas obtained by dividing the space area of the vehicle in advance include two or more of: a left front windshield area, a right front windshield area, a dashboard area, an in-vehicle rearview mirror area, a center console area, a left rearview mirror area, a right rearview mirror area, a visor area, a shift lever area, an area below a steering wheel, a front passenger seat area, or a glove compartment area in front of a front passenger seat.

Further, the second determination unit 13 includes: a first determination sub-unit 131, configured to determine, according to the type distribution of gazing areas of the frames of face images included within at least one sliding time window in the video, an accumulated gazing duration of each type of gazing area within the at least one sliding time window; and a second determination sub-unit 132, configured to determine the attention monitoring result of the driver according to a comparison result between the accumulated gazing duration of each type of gazing area within the at least one sliding time window and a predetermined time threshold, where the attention monitoring result includes whether the driver is in distracted driving and/or a distracted driving level.

Further, the time threshold includes multiple time thresholds corresponding to respective types of defined gazing areas, where the time thresholds corresponding to at least two different types of defined gazing areas in the multiple types of defined gazing areas are different; and the second determination sub-unit 132 is further configured to: determine the attention monitoring result of the driver according to a comparison result between the accumulated gazing duration of each type of gazing area within the at least one sliding time window and a respective time threshold of the type of defined gazing area.

Further, the first determination unit 12 includes: a first detection sub-unit 121, configured to perform line of sight and/or head pose detection on the multiple frames of face images of the driver in the driving area included in the video; and a third determination sub-unit 122, configured to determine the type of the gazing area of the driver in each frame of face image according to the line of sight and/or head pose detection result for the frame of face image.

Further, the first determination unit 12 further includes: a processing sub-unit 123, configured to respectively input the multiple frames of face images into the neural network and respectively output the type of the gazing area of the driver in each frame of face image from the neural network, where the neural network is pre-trained by using a face image set including gazing area type labeling information, or the neural network is pre-trained by using a face image set including gazing area type labeling information and an eye image cropped based on each face image in the face image set; and the gazing area type labeling information includes one of the multiple types of defined gazing areas.

Further, the preset mapping relationship between the distracted driving level and the attention monitoring result includes: in the case that the monitoring results within multiple consecutive sliding time windows are all the distracted driving, the distracted driving level is positively correlated to a number of the sliding time windows.

Further, the first determination unit 12 further includes: a fifth determination sub-unit 124, configured to respectively determine, according to an image quality evaluation index, an image quality score of each frame of face image in the multiple frames of face images of the driver in the driving area included in each of the multiple captured videos; a sixth determination sub-unit 125, configured to respectively determine a face image having a highest image quality score among the frames of face images aligned in time in the multiple videos; and a seventh determination sub-unit 126, configured to respectively determine the type of the gazing area of the driver in each face image having the highest image quality score.

Further, the image quality evaluation index includes at least one of: whether an image includes an eye image, a definition of an eye area in an image, a shielding status of an eye area in an image, or an eye opening/closing status of an eye area in an image.

Further, the first determination unit 12 further includes: a second detection sub-unit 127, configured to respectively detect, for the multiple frames of face images of the driver in the driving area included in each of the multiple captured videos, gazing area types of the driver in the frames of face images aligned in time; and an eighth determination sub-unit 128, configured to determine a majority of obtained gazing area types as the gazing area type of the face images at that time.

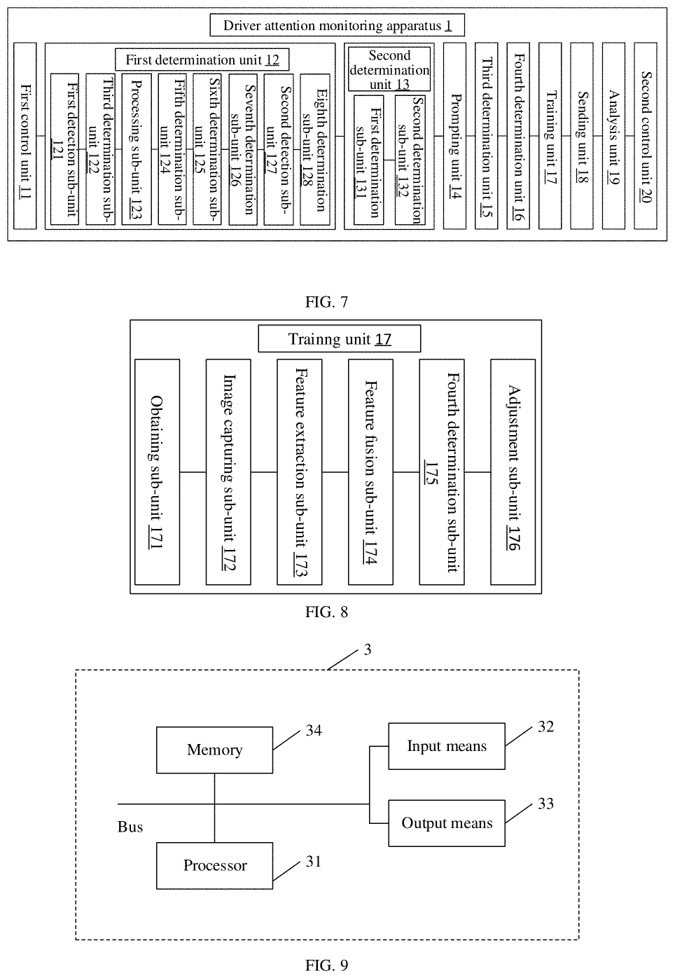

Referring to FIG. 8, FIG. 8 is a schematic structural diagram of a training unit 17 provided in embodiments of the present disclosure. The unit 17 includes: an obtaining sub-unit 171, configured to obtain a face image including gazing area type labeling information in a face image set; an image cropping sub-unit 172, configured to crop an eye image of at least one eye in the face image, where the at least one eye includes the left eye and/or the right eye; a feature extraction sub-unit 173, configured to respectively extract a first feature of the face image and a second feature of the eye image of the at least one eye; a feature fusion sub-unit 174, configured to fuse the first feature and the second feature to obtain a third feature; a fourth determination sub-unit 175, configured to determine a gazing area type detection result of the face image according to the third feature; and an adjustment sub-unit 176, configured to adjust a network parameter of a neural network according to a difference between the gazing area type detection result and the gazing area type labeling information.

In some embodiments, the functions provided by or the modules included in the apparatus provided by the embodiments of the present disclosure may be used to implement the method described in the foregoing method embodiments. For specific implementations, refer to the descriptions of the method embodiments above. For the purpose of brevity, details are not described herein again.

FIG. 9 is a schematic structural diagram of hardware of a driver attention monitoring apparatus provided in embodiments of the present disclosure. The monitoring apparatus 3 includes a processor 31, and can further include an input means 32, an output means 33, and a memory 34. The input means 32, the output means 33, the memory 34, and the processor 31 are connected to one another by means of a bus.

The memory includes, but is not limited to, a Random Access Memory (RAM), a Read-Only Memory (ROM), an Erasable Programmable Read-Only Memory (EPROM), or a Compact Disc Read-Only Memory (CD-ROM), and the memory is used for related instructions and data.

The input means is used for inputting data and/or a signal, and the output means is used for outputting data and/or a signal. The output means and the input means may be separate devices or integrated devices.

The processor may include one or more processors, for example, including one or more Central Processing Units (CPUs). In the case that the processor is a CPU, the CPU may be a single-core CPU or a multi-core CPU.

The memory is used for storing program codes and data of a network device.

The processor is used for calling the program codes and data in the memory, so as to execute steps in the foregoing method embodiments. Refer to the descriptions in method embodiments for details, which are not described herein again.

It can be understood that FIG. 9 merely illustrates a simplified design of the driver attention monitoring apparatus. In practical application, the driver attention monitoring apparatus may further include other necessary components, including but not limited to any number of input/output means, processors, controllers, memories, etc., and all driver attention monitoring apparatuses that can implement the embodiments of the present disclosure fall within the scope of protection of the present disclosure.

Persons of ordinary skill in the art may be aware that, in combination with examples described in the embodiments disclosed in the text, units and algorithm steps may be implemented by electronic hardware, or a combination of computer software and electronic hardware. Whether these functions are implemented by hardware or software depends on the particular application and design constraint conditions of the technical solutions. Persons skilled in the art may use different methods to implement the described functions for each particular application, but it should not be considered that the implementation goes beyond the scope of the present disclosure.

Persons skilled in the art can clearly understand that for convenience and brevity of description, reference is made to corresponding process descriptions in the foregoing method embodiments for the specific working processes of the system, the apparatus, and the units described above. Details are not described herein again. A person skilled in the art can also clearly understand that the description of each embodiment of the present disclosure has its own emphasis. For convenience and brevity of description, the same or similar parts may not be described in different embodiments. Therefore, for parts that are not described or described in details, refer to the descriptions of other embodiments.

It should be understood that the disclosed system, apparatus, and method in the embodiments provided in the present disclosure may be implemented in other modes. For example, the apparatus embodiments described above are merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communicational connections may be implemented by means of some interfaces, and the indirect couplings or communicational connections in the apparatus or units may be implemented in electric, mechanical, or other forms.

The units described as separate parts may or may not be physically separate, and the parts displayed as units may or may not be physical units, i.e., may be located in one position, or may be distributed on multiple network units. A part of or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit.

In the foregoing embodiments, it may be implemented in whole or in part by software, hardware, firmware, or any combination thereof. When implemented by software, it may be implemented in whole or in part in the form of a computer program product. The computer program product includes one or more computer instructions. When the computer program instructions are loaded and executed on a computer, all or part of the processes or functions according to the embodiments of the present disclosure are generated. The computer may be a general-purpose computer, a special-purpose computer, a computer network, or other programmable devices. The computer instructions may be stored in a computer-readable storage medium or transmitted by means of the computer-readable storage medium. The computer instructions may be transmitted from a website site, computer, server, or data center to another website site, computer, server, or data center in a wired (such as a coaxial cable, an optical fiber, and a Digital Subscriber Line (DSL)) or wireless (such as infrared, wireless, and microwave) manner. The computer-readable storage medium may be any available medium that can be accessed by a computer or a data storage device such as a server including one or more available medium integrations and a data center. The available medium may be a magnetic medium (such as a floppy disk, a hard disk, and a magnetic tape), an optical medium (such as a Digital Versatile Disc (DVD)), a semiconductor medium (such as a Solid State Disk (SSD)), or the like.

A person of ordinary skill in the art may understand that all or some processes of implementing the forgoing embodiments of the method may be implemented by a computer program by instructing related hardware; the program may be stored in a computer-readable storage medium; and when the program is executed, processes including the foregoing embodiments of the method are performed. Moreover, the foregoing storage medium includes various media that can store program codes, such as an ROM or RAM, a floppy disk, and an optical disc.

1. A driver attention monitoring method, comprising:
capturing, by a camera arranged on a vehicle, a video of a driving area of the vehicle;
determining, according to each of multiple frames of face images of a driver in the driving area comprised in the video, a type of a gazing area of the driver in the frame of face image, wherein the gazing area of the frame of face image is one of multiple types of defined gazing areas obtained by dividing a space area of the vehicle in advance; and
determining an attention monitoring result of the driver according to a type distribution of gazing areas of the frames of face images comprised within at least one sliding time window in the video.

2. The method according to claim 1, wherein the multiple types of defined gazing areas obtained by dividing the space area of the vehicle in advance comprise two or more of: a left front windshield area, a right front windshield area, a dashboard area, an in-vehicle rearview mirror area, a center console area, a left rearview mirror area, a right rearview mirror area, a visor area, a shift lever area, an area below a steering wheel, a front passenger seat area, or a glove compartment area in front of a front passenger seat.

3. The method according to claim 1, wherein determining the attention monitoring result of the driver according to the type distribution of gazing areas of the frames of face images comprised within at least one sliding time window in the video comprises:
determining, according to the type distribution of gazing areas of the frames of face images comprised within at least one sliding time window in the video, an accumulated gazing duration of each type of gazing area within the at least one sliding time window; and
determining the attention monitoring result of the driver according to a comparison result between the accumulated gazing duration of each type of gazing area within the at least one sliding time window and a predetermined time threshold, wherein the attention monitoring result comprises whether the driver is in distracted driving and/or a distracted driving level.

4. The method according to claim 3, wherein the time threshold comprises multiple time thresholds corresponding to respective types of defined gazing areas, wherein the time thresholds corresponding to at least two different types of defined gazing areas in the multiple types of defined gazing areas are different; and
determining the attention monitoring result of the driver according to the comparison result between the accumulated gazing duration of each type of gazing area within the at least one sliding time window and the predetermined time threshold comprises: determining the attention monitoring result of the driver according to a comparison result between the accumulated gazing duration of each type of gazing area within the at least one sliding time window and a respective time threshold of the type of defined gazing area.

5. The method according to claim 1, wherein determining, according to each of the multiple frames of face images of the driver in the driving area comprised in the video, the type of the gazing area of the driver in the frame of face image comprises:
performing line of sight and/or head pose detection on the multiple frames of face images of the driver in the driving area comprised in the video; and
determining the type of the gazing area of the driver in each frame of face image according to the line of sight and/or head pose detection result for the frame of face image.

6. The method according to claim 1, wherein determining, according to each of the multiple frames of face images of the driver in the driving area comprised in the video, the type of the gazing area of the driver in the frame of face image comprises:
inputting each of the multiple frames of face images into a neural network and outputting the type of the gazing area of the driver in each frame of face image from the neural network, wherein the neural network is pre-trained by using a face image set comprising gazing area type labeling information, or the neural network is pre-trained by using a face image set comprising gazing area type labeling information and an eye image cropped based on each face image in the face image set; and the gazing area type labeling information comprises one of the multiple types of defined gazing areas.

7. The method according to claim 6, wherein a training method for the neural network comprises:
obtaining a face image comprising the gazing area type labeling information in the face image set;
cropping the eye image of at least one eye in the face image, wherein the at least one eye comprises the left eye and/or the right eye;
respectively extracting a first feature of the face image and a second feature of the eye image of the at least one eye;
fusing the first feature and the second feature to obtain a third feature;
determining a gazing area type detection result of the face image according to the third feature; and
adjusting a network parameter of the neural network according to a difference between the gazing area type detection result and the gazing area type labeling information.

8. The method according to claim 1, further comprising:
in the case that the attention monitoring result of the driver is distracted driving, giving the driver a prompt for distracted driving, wherein the prompt for distracted driving comprises at least one of: a text prompt, a voice prompt, a smell prompt, or a low-current stimulation prompt; or
in the case that the attention monitoring result of the driver is the distracted driving, determining a distracted driving level of the driver according to a preset mapping relationship between the distracted driving level and the attention monitoring result and to the attention monitoring result of the driver; and determining, according to a preset mapping relationship between the distracted driving level and a prompt for distracted driving and to the distracted driving level of the driver, a prompt from among prompts for distracted driving to give the driver the prompt for distracted driving.

9. The method according to claim 1, wherein a preset mapping relationship between a distracted driving level and the attention monitoring result comprises: in the case that the monitoring results within multiple consecutive sliding time windows are all distracted driving, the distracted driving level is positively correlated to a number of the sliding time windows.

10. The method according to claim 1, wherein capturing, by the camera arranged on the vehicle, the video of the driving area of the vehicle comprises: respectively capturing, by multiple cameras respectively arranged on multiple areas on the vehicle, videos of the driving area from different angles; and
determining, according to each of the multiple frames of face images of the driver in the driving area comprised in the video, the type of the gazing area of the driver in the frame of face image comprises: respectively determining, according to an image quality evaluation index, an image quality score of each frame of face image in the multiple frames of face images of the driver in the driving area comprised in each of multiple captured videos; respectively determining a face image having a highest image quality score among the frames of face images aligned in time in the multiple captured videos; and respectively determining the type of the gazing area of the driver in each face image having the highest image quality score.

11. The method according to claim 10, wherein the image quality evaluation index comprises at least one of: whether an image comprises an eye image, a definition of an eye area in an image, a shielding status of an eye area in an image, or an eye opening/closing status of an eye area in an image.

12. The method according to claim 1, wherein capturing, by the camera arranged on the vehicle, the video of the driving area of the vehicle comprises: respectively capturing, by multiple cameras respectively arranged on multiple areas on the vehicle, videos of the driving area from different angles; and
determining, according to each of the multiple frames of face images of the driver in the driving area comprised in the video, the type of the gazing area of the driver in the frame of face image comprises: respectively detecting, for the multiple frames of face images of the driver in the driving area comprised in each of multiple captured videos, gazing area types of the driver in the frames of face images aligned in time; and determining a majority of obtained gazing area types as the gazing area type of the face images at that time.

13. The method according to claim 1, further comprising:
sending the attention monitoring result of the driver to a server or a terminal communicationally connected to the vehicle; and/or
performing statistical analysis on the attention monitoring result of the driver.

14. The method according to claim 13, after sending the attention monitoring result of the driver to the server or the terminal communicationally connected to the vehicle, further comprising:
in the case of receiving a control instruction sent by the server or the terminal, controlling the vehicle according to the control instruction.

15. A driver attention monitoring apparatus, comprising:
a memory storing processor-executable instructions; and
a processor arranged to execute the stored processor-executable instructions to perform operations of:
capturing, by a camera arranged on a vehicle, a video of a driving area of the vehicle;
determining, according to each of multiple frames of face images of a driver in the driving area comprised in the video, a type of a gazing area of the driver in the frame of face image, wherein the gazing area of the frame of face image is one of multiple types of defined gazing areas obtained by dividing a space area of the vehicle in advance; and
determining an attention monitoring result of the driver according to a type distribution of gazing areas of the frames of face images comprised within at least one sliding time window in the video.

16. The apparatus according to claim 15, wherein the multiple types of defined gazing areas obtained by dividing the space area of the vehicle in advance comprise two or more of: a left front windshield area, a right front windshield area, a dashboard area, an in-vehicle rearview mirror area, a center console area, a left rearview mirror area, a right rearview mirror area, a visor area, a shift lever area, an area below a steering wheel, a front passenger seat area, or a glove compartment area in front of a front passenger seat.

17. The apparatus according to claim 15, wherein determining the attention monitoring result of the driver according to the type distribution of gazing areas of the frames of face images comprised within at least one sliding time window in the video comprises:
determining, according to the type distribution of gazing areas of the frames of face images comprised within at least one sliding time window in the video, an accumulated gazing duration of each type of gazing area within the at least one sliding time window; and
determining the attention monitoring result of the driver according to a comparison result between the accumulated gazing duration of each type of gazing area within the at least one sliding time window and a predetermined time threshold, the attention monitoring result comprising whether the driver is in distracted driving and/or a distracted driving level.

18. The apparatus according to claim 17, wherein the time threshold comprises multiple time thresholds corresponding to respective types of defined gazing areas, wherein the time thresholds corresponding to at least two different types of defined gazing areas in the multiple types of defined gazing areas are different; and
determining the attention monitoring result of the driver according to the comparison result between the accumulated gazing duration of each type of gazing area within the at least one sliding time window and the predetermined time threshold comprises: determining the attention monitoring result of the driver according to a comparison result between the accumulated gazing duration of each type of gazing area within the at least one sliding time window and a respective time threshold of the type of defined gazing area.

19. The apparatus according to claim 15, wherein determining, according to each of the multiple frames of face images of the driver in the driving area comprised in the video, the type of the gazing area of the driver in the frame of face image comprises:
performing line of sight and/or head pose detection on the multiple frames of face images of the driver in the driving area comprised in the video; and
determining the type of the gazing area of the driver in each frame of face image according to the line of sight and/or head pose detection result for the frame of face image.

20. A non-transitory computer-readable storage medium having stored thereon computer-readable instructions that, when executed by a processor, cause the processor to perform a driver attention monitoring method, the method comprising:
capturing, by a camera arranged on a vehicle, a video of a driving area of the vehicle;
determining, according to each of multiple frames of face images of a driver in the driving area comprised in the video, a type of a gazing area of the driver in the frame of face image, wherein the gazing area of the frame of face image is one of multiple types of defined gazing areas obtained by dividing a space area of the vehicle in advance; and
determining an attention monitoring result of the driver according to a type distribution of gazing areas of the frames of face images comprised within at least one sliding time window in the video.
